(19) United States
(12) Patent Application Publication
(10) Pub. No.: US 2017/0097685 A1
(43) Pub. Date: Apr. 6, 2017

(54) METHOD AND SYSTEM FOR CONTROLLING FIXTURES

(71) Applicant: POINTGRAB LTD., HOD HASHARON (IL)

(72) Inventors: MEIR MORAG, SAVYON (IL); ERAN EILAT, GIVATAYIM (IL); RON SOKOLOVSKY, NES ZIONA (IL)

(21) Appl. No.: 15/307,893

(22) PCT Filed: Apr. 28, 2015
(86) PCT No.: PCT/IL2015/050437

§ 371 Date: Oct. 31, 2016

Related U.S. Application Data
(60) Provisional application No. 61/986,133, filed on Apr. 30, 2014.

(30) Foreign Application Priority Data
Apr. 30, 2014 (IL) 232391

(51) Int. Cl. G06F 3/01; G06K 9/00

(52) U.S. Cl. CPC G06F 3/017; G06F 3/011; G06K 9/00362

(57) ABSTRACT

A method for computer vision based control of a fixture including identifying in an image a user indicating at the fixture and based on the identification of a user indicating at the fixture causing a processor associated with the fixture to generate an identifying signal. The method may include causing a control device to assign the fixture to a group of fixtures based on the identifying signal.

### FIELD OF THE INVENTION

The present invention relates to the field of computer vision based control of electronic devices and functionally grouping devices such as fixtures.

### BACKGROUND

Recently, human gesturing, such as hand gesturing, has been introduced as a user interface input tool in which a hand gesture is detected by a camera and is translated into a specific command Gesture recognition enables humans to interface with devices and interact naturally without any mechanical appliances.

In a multi-device environment, such as in a home or office building, central control of the devices may be desirable. Large scale processes such as project commissioning of a building (the process of checking, inspecting and testing every operational component of the project, e.g., building) may be well served by a simple and easy method for centrally controlling devices and fixtures in the building. In some cases it may be desirable to selectively activate specific fixtures (such as light fixtures) and/or group fixtures for easier control of several fixtures or devices together.

In order to provide central control of devices and/or functionally group devices the devices may be connected using a wired or wireless connection and control logic may be implemented, e.g., using electronic control systems, which may include software running on a control device such as a personal computer (PC), hub or smart phone, to control the fixtures or group of fixtures.

A system for wirelessly connecting light fixtures is described in US publication number 2011/0199004. This system includes using a pointing device which may emit signals, such as visible light or audio signals to sensors associated with a corresponding fixture, such as a light fixture. A control unit may then assign one of the fixtures to a group in response to receipt by the sensor associated with the fixture of a signal emitted by the pointing device.

### SUMMARY

Embodiments of the present invention provide methods and systems for controlling fixtures (e.g., ON/OFF, modulating operation of fixtures and grouping fixtures) based on computer vision, with no need for external pointing devices.

In embodiments of the invention an image of a posture or of a user indicating (e.g., by pointing or using another posture) at a fixture is used to identify the fixture being indicated (e.g., a specific fixture, if there are several fixtures) and that fixture may then be controlled. For example, control may include ON/OFF or modulation of the fixture operation, or, according to one embodiment, the fixture may be controlled to generate an identifying signal which may then be used, for example, to add the fixture to a specified group of fixtures. According to one embodiment an identifying signal generated by an indicated fixture may be used to start up an application on a remote device, the application to control the fixture (or, for example, the group of fixtures which the specific fixture belongs to) through the remote device.

Detecting which fixture is being indicated according to embodiments of the invention, and controlling the fixture based on this identification enables functionally grouping fixtures and easily testing individual fixtures or groups of fixtures without using external pointing devices.

### BRIEF DESCRIPTION OF THE FIGURES

The invention will now be described in relation to certain examples and embodiments with reference to the following illustrative figures so that it may be more fully understood. In the drawings:

FIG. 1 is a schematic illustration of a system according to embodiments of the invention;

FIGS. 2A-D are schematic illustrations of methods and a system for computer vision based control of a fixture or computer vision based grouping of fixtures, according to embodiments of the invention;

FIG. 3 is a schematic illustration of a method for detecting a pointing user, according to embodiments of the invention;

FIG. 4 is a schematic illustration of a method for detecting a pointing user by detecting a combined shape, according to embodiments of the invention; and

FIG. 5 is a schematic illustration of a method for detecting a pointing user by detecting an occluded face, according to embodiments of the invention.

### DETAILED DESCRIPTION OF THE INVENTION

Methods according to embodiments of the invention may be implemented in a system which includes a device or fixture to be controlled (for example, to be grouped to a specified group or otherwise programmed) by a user and an image sensor which is in communication with a processor. The image sensor obtains image data (typically of the user) and sends it to the processor to perform image analysis and to generate control commands to the fixture (typically to a processor associated with the fixture) based on the image analysis, thereby controlling the fixture based on computer vision.

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

“Shape detection algorithms” and “shape recognition algorithms” can be used interchangeably.

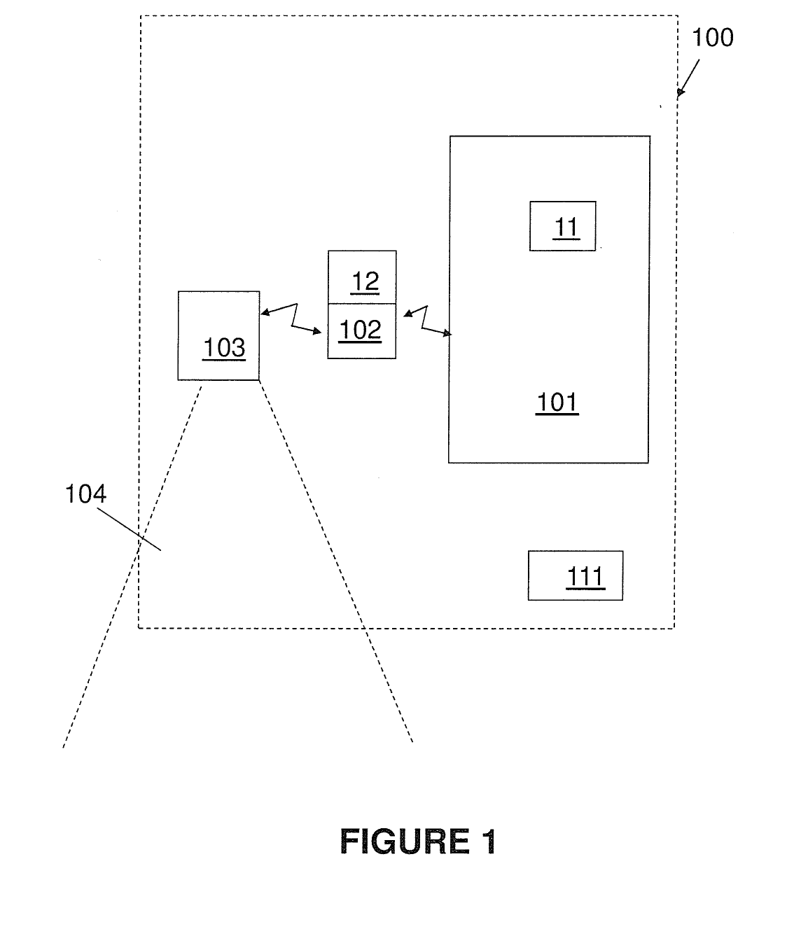

An exemplary system, according to one embodiment of the invention, is schematically described in FIG. 1 however other systems may carry out embodiments of the present invention.

The system 100 may include a camera 103, typically associated with a processor 102, memory 12, and a device, such as fixture 101 having an associated processor 11. The system may further include a control device 111 for receiving signals from processor 11.

The camera 103 sends the processor 102 image data of field of view (FOY) 104 to be analyzed by processor 102. Typically, image signal processing algorithms and/or image acquisition algorithms may be run in processor 102. According to one embodiment a control command or other signal is generated by processor 102 or by another processor, based on the image analysis, and is sent to processor 11 which is associated with fixture 101. Based on the signal or command from processor 102 an identifying signal may be generated by process 11, a signal which may be received by control device 111.

The identifying signal, which typically includes an ID unique to each individual fixture or group of fixtures, and may thus be used to identify the fixture (or group of fixtures), may be wirelessly transmitted such as by light, infrared (IR) communication, radio transmission, Bluetooth technology and other suitable signal transmission techniques.

According to one embodiment a signal from processor 102 received at processor 11 causes processor 11 to assign the fixture 101 to a group of fixtures. For example, a signal received at processor 11 may cause processor 11 to generate an identifying signal which may then be received by the control device 111 (e.g., by a processor of the control device) and the control device may then assign the fixture to a group of fixtures based on the identifying signal.

Control device 111, which may be a device such as a smart phone, tablet, PC or other device such as a programmable logic controller (PLC), may implement logic to group individual fixtures or subgroups of fixtures together, for example, based on functionality, e.g., all outdoor illumination fixtures may be grouped together whereas all ceiling light fixtures may be grouped in another group. In another example light or other fixtures of different floors in a building may be grouped in different groups.

According to one embodiment control device 111 is a device, such as a smart phone or tablet, which can support applications specifically tailored to control fixtures or groups of fixtures. According to one embodiment an identifying signal received by control device 111 may cause such an application to start up on control device 111. The application may enable controlling individual fixtures or groups of fixtures, such as to turn lights or other devices on or off, to dim or otherwise modulate the operation of fixtures or to set operation of the fixtures on a schedule or otherwise program the operation of the fixtures. In another embodiment the application may enable assigning individual fixtures to groups.

In one embodiment the identifying signal received at control device 111 may include information specific to the fixture or to the processor associated with the fixture, such as a unique ID. In some embodiments the identifying signal may include user specific information or other specific information to specify to which control device the identifying signal is relevant. For example, an image of a user indicating at a fixture may be analyzed as to the identity of the user (e.g., by using face detection and recognition) and information on the identity of the user may be included in the identifying signal being sent from the fixture (e.g. by an associated processor) such that the identifying signal is received only by a control device associated with that user (e.g., the user's smart phone or other pre-registered device).

According to some embodiments processor 102 is in communication with the camera 103 and is associated with the fixture 101 such that the same processor may be used for image analysis and for assigning the fixture to a group of fixtures and/or for generating an identifying signal.

Processor 102 may include, for example, one or more processors and may be a central processing unit (CPU), a digital signal processor (DSP), a microprocessor, a controller, a chip, a microchip, an integrated circuit (IC), or any other suitable multi-purpose or specific processor or controller.

Memory unit(s) 12 may include, for example, a random access memory (RAM), a dynamic RAM (DRAM), a flash memory, a volatile memory, a non-volatile memory, a cache memory, a buffer, a short term memory unit, a long term memory unit, or other suitable memory units or storage units.

The fixture 101 may be typically a household or office fixture which may electronically control devices or home appliances such as illumination fixtures (such as a lamp or other light bulb holder), illumination controlling fixtures (such as light switches or dimmers) and air conditioning fixtures. Other fixtures and/or devices may also be within the scope of the invention.

According to one embodiment, fixture 101 is provided with an integrated camera 103, for example, a standard 2D camera.

The processor 102 may be integral to the camera 103 or may be a separate unit. Alternatively, the processor 102 and/or processor 11 may be integrated within the fixture 101. According to other embodiments a first processor may be integrated within the camera and a second processor may be integrated within the fixture. In some embodiments, either processor 102 or 11 or both processors may be remotely located. For example, either processor may be part of another systems (e.g., a processor mostly dedicated to a system's Wi-Fi system or to a thermostat of a system or to LED control of a system, etc., may also be used as a processor according to embodiments of the invention).

The communication between the camera 103 and processor 102 and/or processor 11 and between the processors and the fixture 101 may be through a wired or wireless link, such as through infrared (IR) communication, radio transmission, Bluetooth technology and other suitable communication routes.

According to one embodiment the camera 103 may include a CCD or CMOS or other appropriate image sensor. The camera 103 may be a forward facing camera, typically, a standard 2D camera such as a webcam or other standard video capture device. A 3D camera or stereoscopic camera may also be used according to embodiments of the invention.

According to some embodiments image data may be stored in processor 102 and/or processor 11, for example in a cache memory. Processor 102 and/or processor 11 can apply image analysis algorithms, such as motion detection and shape recognition algorithms to identify and possibly further track a user or, for example, the user's hand Processor 102 and/or processor 11 may perform methods according to embodiments discussed herein by, for example, executing software or instructions stored in memory 12.

According to embodiments of the invention shape recognition algorithms may include, for example, an algorithm which calculates Haar-like features in a Viola-Jones object detection framework.

When discussed herein, a processor such as processors 102 and 11 which may carry out all or part of a method as discussed herein, may be configured to carry out the method by, for example, being associated with or connected to a memory such as memory 12 storing code or software which, when executed by the processor, carry out the method.

Different embodiments are disclosed herein. Features of certain embodiments may be combined with features of other embodiments; thus certain embodiments may be combinations of features of multiple embodiments.

Embodiments of the invention may include an article such as a computer or processor readable non-transitory storage medium, such as for example a memory, a disk drive, or a USB flash memory encoding, including or storing instructions, e.g., computer-executable instructions, which when executed by a processor or controller, cause the processor or controller to carry out methods disclosed herein.

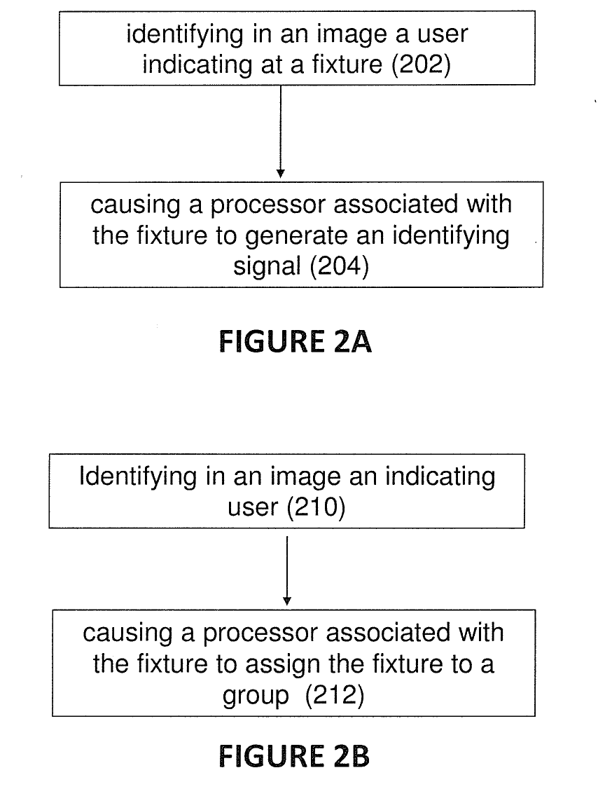

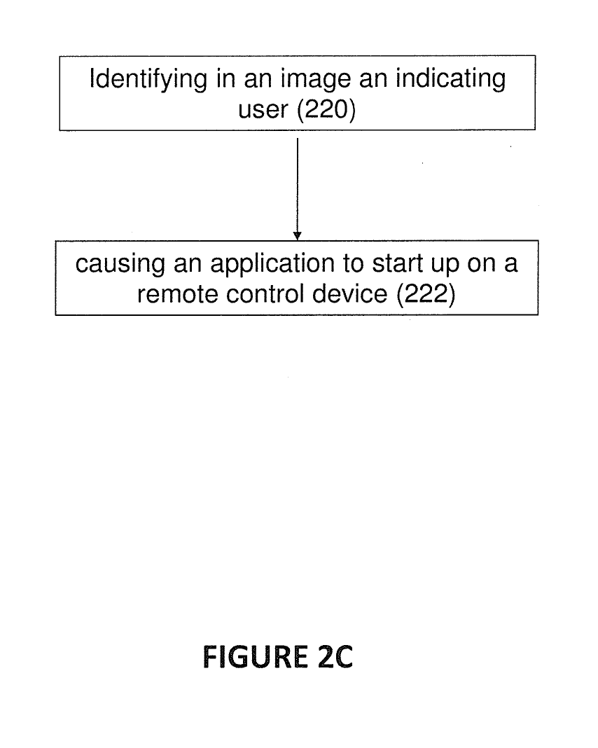

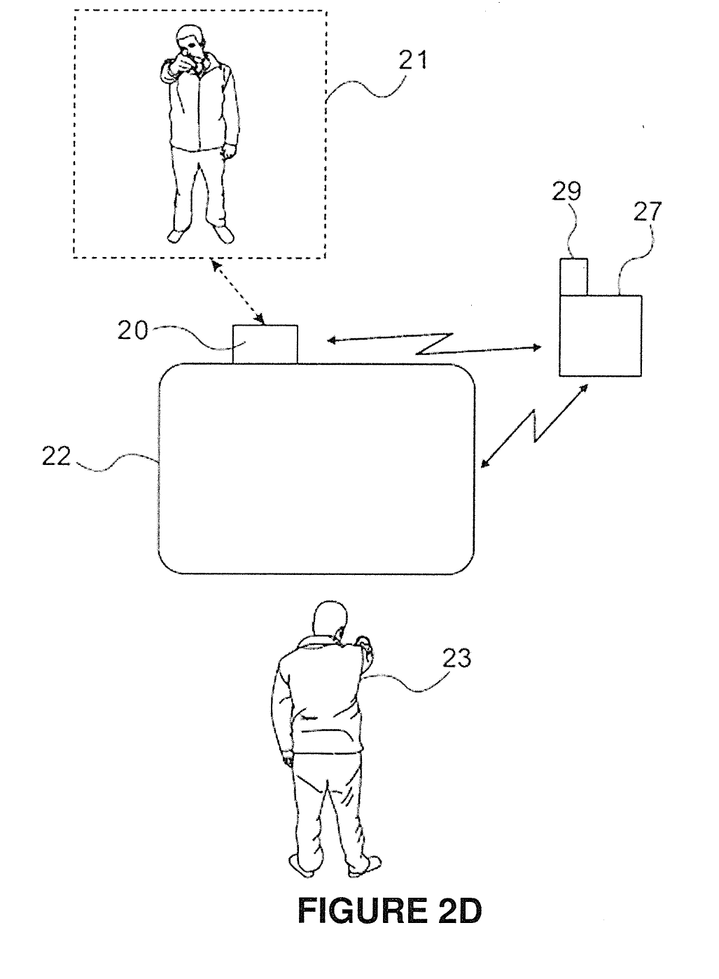

Methods for computer vision based control of a fixture (for example, computer vision based grouping of fixtures), according to embodiments of the invention are schematically illustrated in FIGS. 2A-D.

According to one embodiment, schematically illustrated in FIG. 2A, a method includes identifying in an image a user indicating at a fixture (202) and based on the identification in the image of a user indicating at the fixture, causing a processor associated with the fixture to generate an identifying signal (204).

Identifying a user indicating at a fixture in an image may include detecting and/or identifying a posture or gesture being performed by a user meant to indicate a device or fixture (“indication posture”). For example, shape detection algorithms or other computer vision algorithms may be used to detect and/or identify a posture or gesture in one or more images. Identification of an indicating user may cause a processor to assign the fixture to a group of fixtures or may cause an application to control the fixture or group of fixtures, to start up on a remote control device (for example, based on the identifying signal).

In another embodiment, which is schematically illustrated in FIG. 2B, a method includes identifying in an image a user indicating at a fixture (210) (for example, by applying a shape detection algorithm on the image to identify a shape of an indicating user or to identify a specific posture or gesture being performed by the user) and based on the identification of the user indicating at the fixture, causing a processor associated with the fixture to assign the fixture to a group of fixtures (212).

In another embodiment, which is schematically illustrated in FIG. 2C, a method includes identifying in an image a user indicating at a fixture (220) (for example, by applying a shape detection algorithm on the image to identify a shape of an indicating user or to identify a specific posture or gesture being performed by the user) and based on the identification of a user indicating at the fixture, causing an application to start up on a remote control device (222). According to one embodiment the application is to control the fixture or groups of fixtures.

In one embodiment the methods include applying a shape detection algorithm on the image to identify the user indicating at the fixture.

The step of identifying the user indicating at the fixture may include detecting a shape of a user directing a pre-determined posture at the camera (for example, by applying shape detection algorithms) According to one embodiment the predetermined posture is a shape of a hand which includes pointing. Other postures (such as a fist or open hand) may be used. In some embodiments a pre-determined posture may include a user holding an object or a combined posture of a few body parts or any other posture of the user.

According to some embodiments, described in further detail below, identifying the user indicating at the fixture may include detecting the user's face partially occluded around an area of the user's eyes or detecting a combined shape of the user's face and the user's hand, the user's hand being held away from the user's face or detecting a combined shape of the user's face and the user's hand in a pointing or other pre-determined posture or detecting a static posture of the user. Other methods may be used to identify an indicating user in an image, according to embodiments of the invention.

Methods according to embodiments of the invention typically include obtaining an image via a camera, said camera being in communication with a device, such as a fixture, and detecting in the image a predetermined shape of an object, e.g., a user pointing at the camera. The fixture may then be controlled based on the detection of the user pointing at the camera.

In an embodiment of the invention the camera is integrated within the fixture or is located in close association with the fixture or in close vicinity of the fixture such that a user indicating (e.g., pointing) at the camera is essentially pointing at the fixture. For example, as schematically illustrated in FIG. 2D, camera 20 which is in communication with a processor 27 and memory 29 and is located in the vicinity of fixture 22, obtains an image 21 of a user 23 pointing at the fixture 22. Once a user pointing at the fixture is detected a command may be generated to control the fixture (e.g., a command may be generated for a processor to generate and/or send an identifying signal). Since the camera 20 is located in the vicinity of the fixture 22, an image of a user pointing at the fixture will be similar to an image of a user pointing (or otherwise indicating) at the camera.

Communication between the camera 20 and the fixture 22 and processor 27 and memory 29 may be through a wired or wireless link, such as described above.

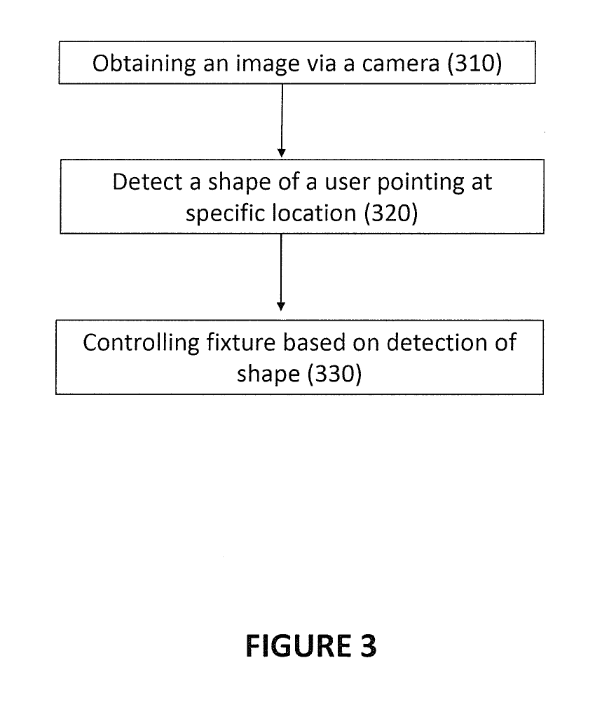

According to one embodiment which is schematically illustrated in FIG. 3, the method includes obtaining an image via a camera (310), said camera being in communication with a fixture. In the image a shape of a user indicating (e.g., by pointing or otherwise posturing) at the camera (or at a different location related to the camera) is detected (320) and based on the detection of the shape of the user indicating at the camera (or other location, such as at the center of the fixture), generating a command to control the fixture (330).

According to one embodiment a detector trained to recognize a shape of a pointing (or otherwise indicating) person is used to detect the shape of the user pointing (or otherwise indicating) at the camera or at a different location related to the camera. Shape detection algorithms, such as described above, may be used.

A shape of a user pointing or otherwise indicating at the camera can be detected in a single image, unlike detecting gestures which involve motion, which cannot be detected from a single image but requires checking at least two images.

According to one embodiment the camera is a 2D camera and the detector's training input includes information from 2D images.

When indicating at a camera or at a location in the vicinity of the camera, such as pointing at a fixture which includes the camera, the user is essentially looking at the camera and is holding his pointing finger (or other posturing hand or object) in the line of sight between his eyes and the camera. Thus, a “shape of an indicating user”, according to one embodiment, will typically include at least part of the user's face. According to some embodiments a “shape of an indicating user” includes a combined shape of the user's face and the user's hand in a pointing (or other) posture (as can be seen for example in image 21 in FIG. 2D).

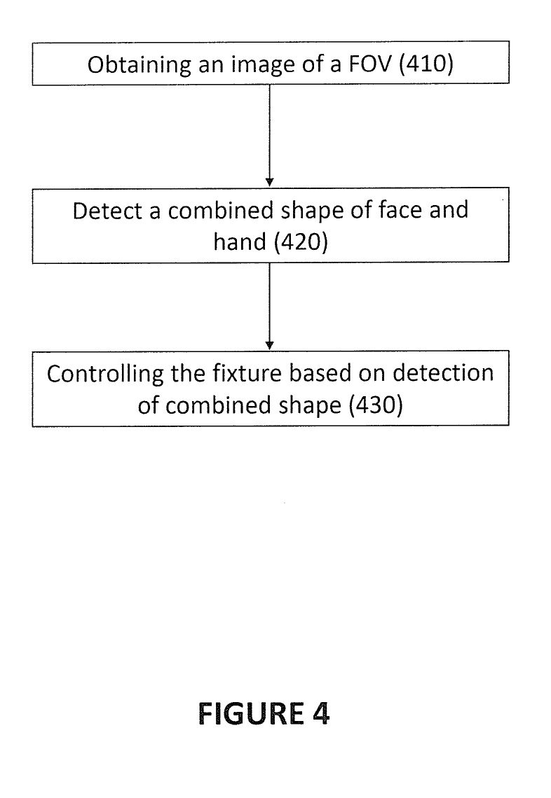

Thus, a method for computer vision based control of a fixture according to one embodiment, which is schematically illustrated in FIG. 4, includes the steps of obtaining an image of a field of view, the field of view including at least part of a user (410) and detecting a combined shape of the user's face (or part of the user's face) and the user's hand in a pointing (or other) posture (420). A fixture may then be controlled based on the detection of the combined shape (430).

According to another embodiment the fixture may be controlled based on detecting a combined shape of the user's face and the user's hand, the user's hand being held away from the user's face. Thus, a user does not necessarily have point or posture in order to indicate a desired fixture. The user may be looking at a desired fixture (or at the camera attached to the fixture) and may raise his arm in the direction he is looking at, thus indicating that fixture.

For example, detection of a combined shape of the user's face (or part of the user's face) and the user's hand held at a distance from the face (but in the line of sight between his eyes and the camera), for example, in a pointing (or other) posture, may generate a command causing a processor associated with the fixture to generate an identifying signal. The identifying signal may then be used to, for example, assign the fixture to a group of fixtures or cause an application to start up on a control device, e.g., by generating an identifying signal, for example as described above.

According to one embodiment one or more detectors may be used to detect a combined shape. For example, one detector may identify a partially obscured face whereas another detector may identify a hand or part of a hand on a background of a face. One or both detectors may be used in identifying a user indicating at a camera.

A face or facial landmarks may be continuously or periodically searched for in the images and may be detected, for example, using known face detection algorithms (e.g., using Intel's OpenCV). According to some embodiments a shape can be detected or identified in an image, as the combined shape, only if a face was detected in that image. Thus, in one embodiment the method includes identifying in an image a posture or gesture (e.g., a user indicating at a fixture) and detecting a face in the image and based on the identification in the image of the posture or gesture and the detection of the face, causing a processor associated with the fixture to generate an identifying signal.

In some embodiments the search for facial landmarks and/or for the combined shape may be limited to a certain area in the image (thereby reducing computing power) based for example, on size (limiting the size of the searched area, for example, based on an estimated or average face size), on location (e.g., based on the expected location of the face) and/or on other suitable parameters.

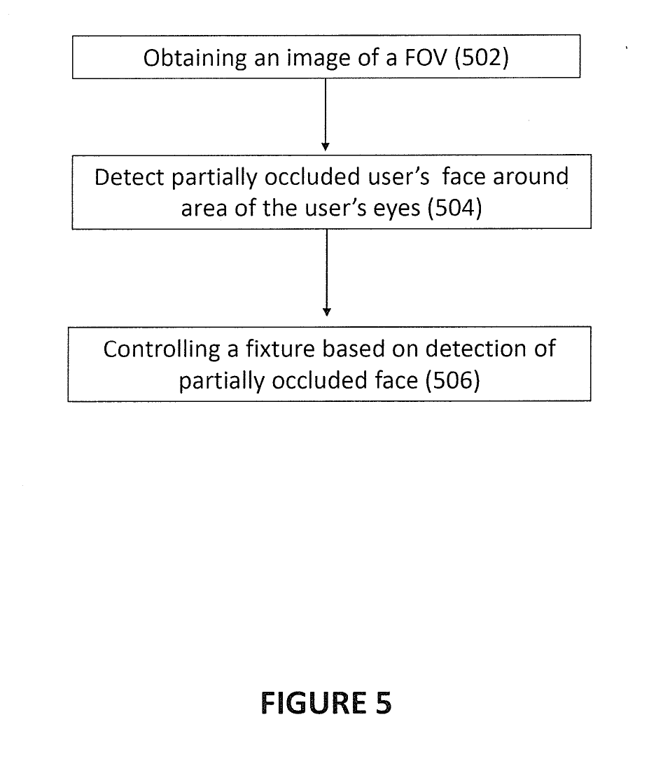

According to another embodiment detection of a user indicating at the camera or at a different location related to the camera may be done by identifying a partially occluded face. For example, as schematically illustrated in FIG. 5, a method according to one embodiment of the invention may include the steps of obtaining an image via a camera (502); detecting in the image a user's face partially occluded around an area of the user's eyes (504); and controlling fixture based on the detection of the partially occluded user's face (506).

The area of the eyes may be detected within a face by detecting a face (e.g., as described above) and then detecting an area of the eyes within the face. According to some embodiments an eye detector may be used to detect at least one of the user's eyes. Eye detection using OpenCV's boosted cascade of Haar-like features may be applied. Other methods may be used. The method may further include tracking at least one of the user's eyes (e.g., by using known eye trackers).

According to one embodiment the user's dominant eye is detected, or the location in the image of the dominant eye is detected, and is used to detect a pointing user. Eye dominance (also known as ocular dominance) is the tendency to prefer visual input from one eye to the other. In normal human vision there is an effect of parallax, and therefore the dominant eye is the one that is primarily relied on for precise positional information. Thus, detecting the user's dominant eye and using the dominant eye as a reference point for detecting a pointing user, may assist in more accurate control of a fixture.

According to one embodiment the method includes detecting a shape of a partially occluded user's face. According to one embodiment the face is partially occluded by a hand or part of a hand

The partially occluded face may be detected in a single image by using one or more detectors, for example, as described above.

According to one embodiment, for example in an environment having a plurality of fixtures, the system identifies an “indication posture” and can thus determine which fixture (of several fixtures) is being indicated by the user. The “indication posture” may be a static posture (such as the user pointing at the fixture or at the camera associated with the fixture). According to one embodiment a system includes a camera operating at a low frame rate and/or having a long exposure time such that motion causes blurriness and is easily detected and discarded, facilitating detection of the static “indication posture”.

1. A method for computer vision based control of a fixture, the method comprising
identifying in an image a user indicating at the fixture ; and
based on the identification of a user indicating at the fixture causing a processor associated with the fixture to generate an identifying signal.

2. The method of claim 1 comprising causing a control device to assign the fixture to a group of fixtures based on the identifying signal.

3. The method of claim 1 comprising causing an application to start up on a control device based on the identifying signal.

4. The method of claim 3 wherein the the application is to control the fixture or groups of fixtures.

5. The method of claim 1 comprising applying a shape detection algorithm on the image to identify a user indicating at the fixture.

6. The method of claim 1 wherein identifying a user indicating at the fixture comprises detecting a shape of a user directing a pre-determined posture at the camera.

7. The method of claim 1 wherein identifying a user indicating at the fixture comprises detecting the user's face partially occluded around an area of the user's eyes.

8. The method of claim 1 wherein identifying a user indicating at the fixture comprises detecting a combined shape of the user's face and the user's hand, the user's hand being held away from the user's face.

9. The method of claim 1 wherein identifying a user indicating at the fixture comprises detecting a combined shape of the user's face and the user's hand

10. A method for computer vision based grouping of fixtures, the method comprising identifying in an image a shape of a user indicating at a fixture; and
based on the identification of the shape of a user indicating at the fixture causing a control device to assign the fixture to a group of fixtures.

11. The method of claim 10 comprising applying a shape recognition algorithm on the image to identify the shape of a user indicating at the fixture.

12. The method of claim 10 comprising causing a processor associated with the fixture to generate an identifying signal, said identifying signal to be received by the control device and wherein the control device assigns the fixture to a group of fixtures based on the identifying signal.

13. The method of claim 10 comprising causing a processor associated with the fixture to generate an identifying signal, said identifying signal to be received by the control device and wherein based on the identifying signal an application is run on the control device, the application to control the fixture or a groups of fixtures.

14. A system for computer vision based control of a device, the system comprising
a device;
a camera configured to capture an image of at least part of a user;
a processor in communication with the camera and associated with the device, said processor to detect in the image a user indicating at the device and to generate an identifying signal based on the detection in the image of a user indicating at the device.

15. The system of claim 14 wherein the processor is to assign the device to a group of devices based on the identifying signal.

16. The system of claim 14 comprising a control device, said control device configured to receive the identifying signal and to control the device based on the identifying signal.

17. The system of claim 16 wherein the control device is to assign the device to a group of devices based on the identifying signal.

18. The system of claim 16 wherein the control device is to run an application, the application to control the device or groups of devices.

19. The system of claim 14 wherein the device is selected from an illumination fixture, an illumination controlling fixture and an air conditioning fixture.

20. The system of claim 16 wherein the control device is a smart phone or tablet.
